(19) United States
(12) Patent Application Publication
(10) Pub. No.: US 2025/0145103 A1
(43) Pub. Date: May 8, 2025

(54) Tool and Method for Producing an Airbag Assembly

(71) Applicant: Bayerische Motoren Werke Aktiengesellschaft, Muenchen (DE)

(72) Inventors: Martin HEINRICH, Rottenburg A. D. Laaber (DE); Johannes HUBER, Pfeffenhausen (DE); Martin SCHWABL, Hohenthann (DE)

(21) Appl. No.: 18/837,916

(22) PCT Filed: Apr. 4, 2023
(86) PCT No.: PCT/EP2023/058823

§ 371 Date: Aug. 13, 2024

(30) Foreign Application Priority Data
Apr. 27, 2022 (DE) 10 2022 110 150.9

(51) Int. Cl. B60R 21/235; B29C 70/22; B29C 70/48; B29C 70/54; B29K 105/08; B29L 22/02

(52) U.S. Cl. CPC B60R 21/235; B29C 70/22; B29C 70/48; B29C 70/543; B29K 2105/0845; B29L 2022/027; B60R 2021/23509; B60R 2021/23557

(57) ABSTRACT

A tool comprising two tool halves formed by at least one upper tool and at least one lower tool, which together form a cavity for producing an airbag assembly with a flap component and a chute channel component. The cavity has a flap cavity and a chute channel cavity, wherein, in the lower tool, a first cavity wall section is formed which partially borders the flap cavity, and second cavity wall sections are formed which border the chute channel cavity. The tool also has at least one bending element which can be moved between an insertion position and a bending position and is designed to introduce sections of a material web, attached to the first cavity wall section and protruding over the chute channel cavity with one section, into the chute channel cavity when moving from the insertion position into the bending position.

### BACKGROUND AND SUMMARY

This disclosure relates to a tool and a method for producing an airbag assembly.

An airbag assembly for a motor vehicle includes an airbag cover, which closes a passage opening for the airbag. The airbag assembly can be integrated into a vehicle trim component, for example an instrument panel support. The airbag cover is usually fastened by way of a hinge to the vehicle trim component or the chute channel.

When the airbag is triggered, it is forced through the chute channel and forces the airbag cover open at great speed. The hinge has the object of preventing the airbag cover being completely detached and representing a danger to the vehicle occupants.

The document DE 10 2017 100 330 A1 discloses an airbag assembly having a flap component, which closes a passage opening for the airbag. A hinge section is arranged along one side of the flap and a chute channel component is connected to the flap via the hinge section. A material web is arranged partly in the flap and partly in the chute channel component and crosses the hinge section. The material web is molded into the chute channel component anchored in the material of the chute channel component.

This airbag assembly is produced in the injection molding process, for which purpose the material web is inserted into the injection molding tool and then overmolded. The chute channel component is aligned at an angle of substantially 90° to the hinge section, so that the material web must likewise be bent through this angle.

Against this background, it is an object of the disclosure to indicate a possible way as to how such an airbag assembly can be produced in a process-reliable manner. In a further aspect, it should be possible to carry out the production quickly and with low costs.

A tool is specified which has tool halves formed by at least one upper tool and at least one lower tool, which together form a cavity for the production of an airbag assembly. The terms upper tool and lower tool are to be understood such that the upper tool is preferably arranged above the lower tool but does not have to be. It is conceivable to rotate the arrangement; likewise the upper tool and lower tool can, for example, also be arranged beside each other. By way of a movement of the two tool halves toward each other, the upper tool and lower tool can be closed, whereby the cavity is formed.

The airbag assembly to be produced is intended to comprise a flap component and a chute channel component. The chute channel can in particular be formed as a closed-wall channel, which is closed at one end by the flap. Accordingly, the cavity of the tool has a flap cavity and a chute channel cavity. A first cavity wall section, which partly delimits the flap cavity, is formed in the lower tool. In addition, second cavity wall sections, which delimit the chute channel cavity, are formed in the lower tool. The tool also has at least one bending element, which can be moved between an insertion position and a bending position and is configured to insert a material web, which is attached to the first cavity wall section and of which one section projects beyond the chute channel cavity, section by section into the chute channel cavity by moving the bending element from the insertion position into the bending position. During the positional change from the insertion position into the bending position, the effect of the bending element is that the material web initially resting substantially flat on the lower tool is bent section by section into the chute channel cavity.

Also specified is a method for producing an airbag assembly having a flap component and a chute channel component. The method includes the steps of:
providing a tool according to the disclosure and opening the two tool halves,
inserting a material web into the first cavity wall section, fixing the material web to the first cavity wall section and moving the at least one bending element into the insertion position, so that a section of the material web comes to lie between the bending element and the chute channel cavity,
moving the at least one bending tool into the bending position, whereby the section of the material web is inserted into the chute channel cavity,
closing the two tool halves and introducing a matrix material into the cavity to form the airbag assembly.

The insertion is carried out with the tool opened and, for example, can be carried out automatically by way of a multi-axis industrial robot. The industrial robot can also fix the material web by holding it in a defined position while the material web is introduced section by section into the chute channel cavity.

The bending element can already be moved into the insertion position when the material web is inserted. Alternatively, the bending element can also be moved into the insertion position in parallel with the insertion or following the insertion of the material web. This is carried out when the bending element is moved and by it being moved back into the bending position. During this movement, the bending element carries with it the section of the material web projecting beyond the chute channel cavity in the direction of the chute channel and bends it. Once the bending element has been moved back completely into the bending position, then it forms a boundary of the chute channel cavity. The section of the material web is then located within the chute channel cavity.

In a preferred refinement, the tool has a further bending element, which is configured to introduce a further section of the material web into the chute channel cavity by moving from the insertion position into the bending position. The two bending elements are arranged on opposite sides of the flap cavity. This advantageously permits symmetrical introduction of the material web into the chute channel cavity. This reduces the danger that the material web slips or creases during the insertion. In addition, the forces needed to fix the material web are reduced.

The bending element is preferably designed as a slider. In the bending position, the slider is recessed in a slider holder in the lower tool and forms a section of the second cavity wall section. The slider has a shoulder surface, which faces away from the upper tool. When moving from the bending position into the insertion position, the bending element is moved in the direction of the upper tool. In the insertion position, the bending element projects in the direction of the upper tool and no longer delimits the chute channel cavity. In the insertion position, the slider is moved so far in the direction of the upper tool that the shoulder surface projects with respect to the first cavity wall section and a free space is formed between the shoulder face and the slider holder. This produces additional space in which the material web can be bent.

If the slider is retracted in the direction of the bending position, then the shoulder surface comes into contact with the material web. During the further retraction, the shoulder surface carries the material web with it into the slider holder, wherein the material web slides along on the shoulder surface, is bent and drawn into the chute channel cavity. When the slider is again located in the bending position, the section of the material web that has been drawn in is accommodated in the chute channel cavity. The shoulder surface can have an increased roughness and/or a geometry which facilitates the bending and drawing-in, such as a convex course. The slider is preferably moved linearly into the insertion position. The movement of the slider is preferably carried out parallel to the direction of the depth of the chute channel cavity. This promotes crease-free pulling of the material web into the cavity.

As a result of using the slider or sliders described above as a bending element, it becomes possible to introduce material webs quickly, economically and in a way that is suitable for large-scale production, even into very narrow chute channel cavities. In a preferred refinement, the chute channel cavity adjoining the slider has a width of no more than 4 mm. This permits a saving in material and weight to be realized in the airbag assembly.

In order to ensure that the section of the material web is drawn completely into the chute channel cavity, it is advantageous in one refinement if the shoulder surface of the at least one slider, when the latter is in the insertion position, is spaced apart by a distance from the first cavity wall section, this distance being at least as large as the distance by which the material web is drawn into the chute channel cavity when the slider is retracted into the bending position. Such a spacing provides sufficient space in order that when it is laid on the first cavity wall section, the material web already moves past the bending elements and comes to lie with sections overlapping the chute channel cavity. This simplifies the subsequent insertion into the chute channel cavity and reduces the forces needed for this. The material web is stressed less and the tool can be configured more economically.

The fixing of the material web can be carried out by way of the industrial robot. In order to prevent the material web from slipping, provision is made in one refinement for the tool also to have fixing elements, which are arranged on the first cavity wall section and project into the flap cavity. The fixing elements can be, for example, cylindrical pins or needle-like protrusions, onto which the material web is pulled. The material web can be provided with holes for this purpose.

Matrix material is introduced into the closed tool to produce the airbag assembly. In the airbag assembly, material web is incorporated in the matrix material. In a preferred refinement, a thermoplastic matrix material is used. This can be sprayed into the tool, for example, if, in one refinement, the tool is an injection molding tool. Alternatively, a thermosetting matrix material can also be used; the tool can accordingly be an RTM tool.

The material web is preferably a textile material which, for example, can have carbon fibers, glass fibers, polyester fibers, aramid fibers and/or natural fibers. The material web preferably has only a low inherent stiffness and, at the start of the method, is present as a flat semifinished product. The material web can in particular be a woven fabric, preferably made of long or continuous fibers.

The disclosure makes it possible for the material web to be supplied as a flat web material and to be brought reliably into position directly in the production process of the component. Flat material webs need less stacking height and storage area than pre-formed semifinished products. In addition, the necessity for mechanical bending in a pre-process is dispensed with, so that it is possible to dispense with a separate bending system and complicated grippers required for this. Since this is a safety component, this process would additionally require documentation. In addition, the method is not associated with any noticeable increase in the processing time. The waste can be reduced considerably as compared with threading the material webs in. The introduction of the material web into the chute channel cavity by way of bending elements integrated into the tool is particularly error-free and process-reliable.

Features and details which are described in connection with the device also apply in connection with the method according to the disclosure and vice versa in each case, so that with respect to the disclosure relating to the individual aspects of the disclosure, reference is or can always be made reciprocally.

Further advantages, features and details of the disclosure can be gathered from the following description in which, with reference to the figures, exemplary embodiments of the disclosure are described in detail. The features mentioned in the claims and in the description can be important to the disclosure, in each case individually or in any desired combination. If the term “can” is used in this application, this involves both the technical possibility and also the actual technical implementation.

### BRIEF DESCRIPTION OF THE DRAWINGS

Exemplary embodiments are explained below by using the appended drawings.

FIG. 1 shows a sectional view of an example of a tool for an airbag assembly;

FIG. 2 shows a sectional view of the lower tool of the tool from FIG. 1;

FIG. 3 shows a schematic illustration of an example of a method for producing an airbag assembly; and,

FIG. 4 shows a sectional view of a further example of a lower tool.

### DETAILED DESCRIPTION OF THE DRAWINGS

FIG. 1 shows an example of a tool 1 in a sectional illustration. The tool 1 has two tool halves with a lower tool 10 and an upper tool 20 which, together, form a cavity 30 for producing an airbag assembly having a flat component and a chute channel component. Accordingly, the cavity 30 has a flap cavity 32 and a chute channel cavity 34. The chute channel can in particular be designed as a closed-wall channel, which is closed at one end by the flap. The flap cavity 32 and the chute channel cavity 34 can be connected directly or by hinge cavities not shown. A hinge cavity can, for example, be designed to produce a thinned cover section, so that this section functions as a type of intended fracture point when the airbag is triggered.

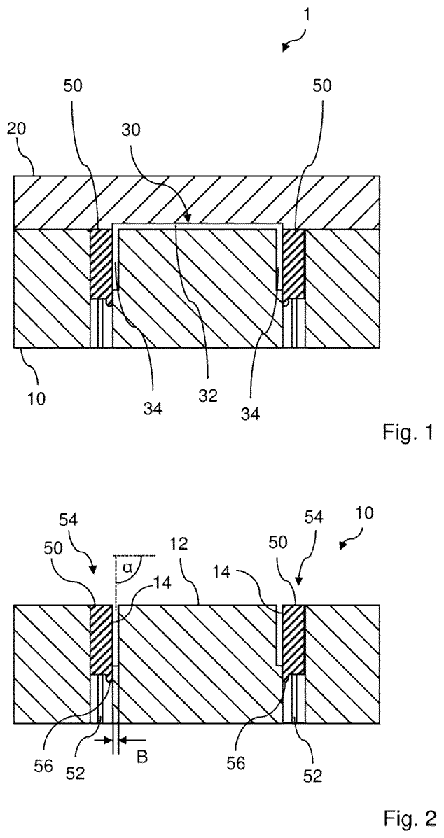

The lower tool 10 has a first cavity wall section 12, which partly delimits the flap cavity 32, and second cavity wall sections 14, which delimit the chute channel cavity 34, see also FIG. 2.

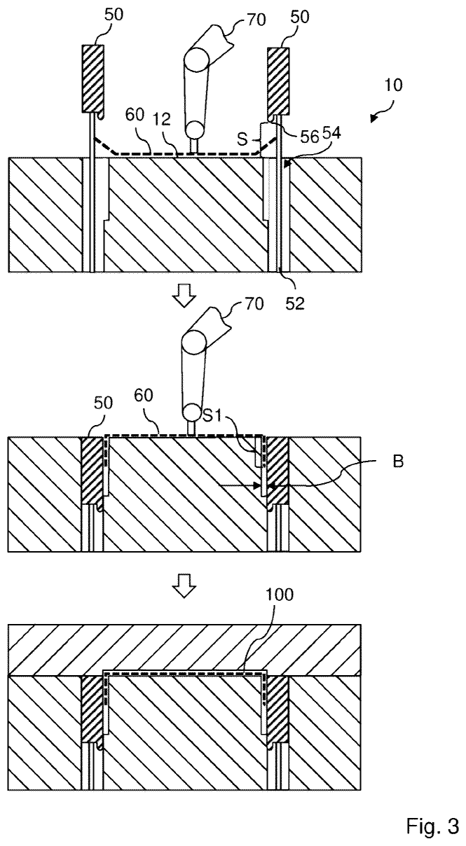

Provided in the tool 1 are two bending elements 50 in the form of sliders, which can each be moved from a bending position (illustrated in FIG. 1) to an insertion position (see FIG. 3). The bending elements 50 are arranged on opposite sides of the flap cavity 32. To this end, the bending elements 50 can be displaced axially by way of cylinders 52. Each slider is accommodated in a slider holder 54 in the bending position and forms a section of the second cavity wall section 14. The sliders are preferably arranged on an outer side of the chute channel cavity 34. In addition, each slider has a shoulder surface 56, which faces away from the flap cavity 32.

FIG. 3 shows, schematically, method steps of an example of a method for producing an airbag assembly having a flap element at a chute channel element. The method is performed with the tool 1 from FIG. 1; in this sense the same designations designate the same features and are not described again.

Firstly, the tool 1 is opened and a material web 60 is laid on the first cavity wall section 12 of the lower tool 10. The material web 60 is provided as a flat semifinished product, which is cut to the suitable size. The material web 60 is sufficiently large that it spans the flap cavity 32 and can reach into the chute channel cavity 34 on both sides. Insertion of the material web 60 can be done by hand or automatically, for example by an industrial robot 70, as illustrated in FIG. 2. The bending elements 50 are moved into the insertion position. This is preferably done before the insertion of the material web 60 but can also be carried out in parallel thereto or following the insertion of the material web 60.

Because the bending elements 50 are moved into the insertion position, a region underneath the bending elements 50 becomes free. The shoulder surface 56 then projects by a distance S with respect to the first cavity wall section 12, and a free space is formed between the shoulder surface 56 and the slider holder 54. The material web 60 is laid on the first cavity wall section 12 such that it projects beyond the flap cavity 34 on both sides. Because of the low inherent stiffness of the textile material 60, as it is inserted it slips past the bending elements 50 into the clear space underneath the bending elements 50 and, for example, rests on the cylinders 52.

The bending elements 50 are then retracted into the bending position, whereby the shoulder surface 56 comes into contact with the material web 60 and draws the latter into the chute channel cavity 34 during the retraction movement. By using the tool 1 and the method, it is in particular possible to draw the material web 60 reliably, quickly and cost-effectively even into cavities that are very narrow and angled over sharply with respect to the tool closing plane. Thus, the chute channel cavity 34 adjoining the bending element 50 can, for example, have a width B of no more than 4 mm. The chute channel cavity 34 can be inclined with respect to the tool closing plane, for example by an angle α in the range from 45 to 90°, see FIG. 2.

The bending element 50 is preferably configured in such a way that the distance S by which the shoulder surface 56 is spaced apart from the first cavity wall section 12 when the bending element 50 is in the insertion position is at least as large as the distance S1 by which the material web 60 is drawn into the chute channel cavity 34. Hereby, optimal and fold-free drawing of the material web 60 into the chute channel cavity 34 is achieved.

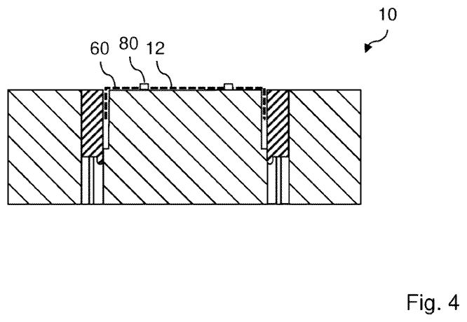

Up to this point in time, the material web 60 is fixed to the first cavity wall section 12. This can be done by way of the industrial robot 70. Alternatively, the first tool half 10 can also have fixing elements, which are configured to hold the material web 60 in the predetermined place. FIG. 4 shows examples of fixing elements 80 in the form of cylindrical pins, which project from the first cavity wall section 12 in the direction of the flap cavity. The material web 60 can then have cutouts, for example, with which it is threaded onto the fixing elements 80.

In a next step, the tool 1 is closed by moving the two tool halves 10 and 20 together and a matrix material is introduced into the cavity 30 to produce the airbag assembly 100. The tool 1 is preferably an injection molding tool. Accordingly, in the method a thermoplastic material can be injected into the cavity 30. However, it is also conceivable that the tool 1 is an RTM tool, for example, and a thermosetting matrix material is used.

### LIST OF DESIGNATIONS

1 Tool
10 Lower tool
12, 14 Cavity wall section
20 Upper tool
30 Cavity
32 Flap cavity
34 Chute channel cavity
50 Bending element
52 Cylinder
54 Slider holder
56 Shoulder surface
60 Material web
70 Industrial robot
80 Fixing elements
100 Airbag assembly
S, S1 Distance
α Angle

1.-10. (canceled)

11. A tool comprising:
two tool halves formed by at least one upper tool and at least one lower tool, which together form a cavity for producing an airbag assembly having a flap component and a chute channel component, wherein the cavity has a flap cavity and a chute channel cavity, wherein a first cavity wall section which at least partly delimits the flap cavity is formed in the lower tool, and second cavity wall sections are formed, which delimit the chute channel cavity, and
the tool also has at least one bending element, which can be moved between an insertion position and a bending position and is configured to insert a material web, which is attached to the first cavity wall section and of which one section projects beyond the chute channel cavity, section by section into the chute channel cavity when moving from the insertion position into the bending position.

12. The tool according to claim 11,
having a further bending element, which is configured to introduce a further section of the material web into the chute channel cavity by moving from the insertion position into the bending position, wherein the two bending elements are arranged on opposite sides of the flap cavity.

13. The tool according to claim 11, in which
the bending element is designed as a slider which, in the bending position, is recessed in a slider holder in the lower tool and forms a section of the second cavity wall section and also has a shoulder surface facing away from the upper tool (20),
wherein, in the insertion position, the slider is moved so far in the direction of the upper tool that the shoulder surface projects with respect to the first cavity wall section and a free space is formed between the shoulder surface and the slider holder.

14. The tool according to claim 13,
in which the chute channel cavity (34) adjoining the slider has a width of no more than 4 mm.

15. The tool according to claim 11,
further having fixing elements, which are arranged on the first cavity wall section and project into the flap cavity.

16. The tool according to claim 11, in which it is an injection molding tool.

17. A method for producing an airbag assembly having a flap component and a chute channel component, having the steps:
providing a tool according to claim 11 and opening the two tool halves,
inserting a material web into the first cavity wall section, fixing the material web to the first cavity wall section and moving the at least one bending element into the insertion position, so that a section of the material web comes to lie between the bending element and the chute channel cavity,
moving the at least one bending tool into the bending position, whereby the section of the material web is inserted into the chute channel cavity,
closing the two tool halves and introducing a matrix material into the cavity to form the airbag assembly.

18. The method according to claim 17, wherein the material web is a woven fabric.

19. The method according to claim 17, in which
a thermoplastic material is injected into the cavity.

20. The method according to claim 17, having a tool according to claim 3, in which
the shoulder surface of the at least one slider, when the latter is in the insertion position, is spaced apart from the first cavity wall section by a distance, and
wherein this distance is at least as great as a distance by which the material web is drawn into the chute channel cavity when the slider is retracted into the bending position.
